(19) United States
(12) Patent Application Publication
(10) Pub. No.: US 2007/0285940 A1
(43) Pub. Date: Dec. 13, 2007

(54) A LUMINAIRE

(76) Inventor: Christina Marie VALENTINE, Chiselhurst (GB)

Correspondence Address: SCHNECK & SCHNECK, P.O. BOX 2-E, SAN JOSE, CA, 95109-0005, US

(21) Appl. No.: 11/423,921

(22) Filed: Jun. 13, 2006

(51) Int. Cl. G02B 6/00

(52) U.S. Cl. 362/551

(57) ABSTRACT

A preferred embodiment of the present invention relates to a luminaire (21; 54; 57) comprising: a light source (35), and a frame (27) having a plurality of optic fiber stubs (31) retained therein, said stubs (31) being selectively movable by a user with respect to the frame (27) to form a three-dimensional surface that may be lit by said light source (35) when said frame (27) is located in front of said light source (35) and said light source (35) is energised.

### FIELD OF THE INVENTION

This invention relates to luminaires. A particularly preferred embodiment of the invention relates to a luminaire that employs a plurality of optical fibers which can be moved to form a three-dimensional surface.

### BACKGROUND TO THE INVENTION

It has previously been proposed to provide so-called “pin art” devices wherein a plurality of moveable pins are mounted in a frame, and the pins can be moved out of the plane of the frame to form a three dimensional surface. One such previously proposed device, available online from the Science eStore at www.physlink.com, is shown schematically in FIGS. 1 and 2, wherein FIG. 1 is a schematic perspective view of the device and FIG. 2 is a top plan view of the device.

Referring to FIGS. 1 and 2, this previously proposed pin art device 1 comprises a plurality of pins 3 mounted in a frame consisting of a first 5 and a second 7 parallel plates, the plates being provided with a plurality of holes (not visible) and arranged such that the holes in one said plate are aligned with those in the other.

The pins each comprise a pin shaft 9 and a pin head 11, and the head is larger than the shaft so as to stop the pins from failing out of the frame in a direction A. To prevent the pins from failing out of the frame in an opposite direction B, a clear acetate cover 13 is mounted to the frame by means of a plurality of bolts and spacers 15 which space the cover from the frame by a distance which is less than the length of the pin shafts.

With this device it is possible to create a three-dimensional surface by pressing an object into the pins from the back of the frame so as to move one or more of the pins (in direction B) from a position where the heads of the pin lie against the second parallel plate to a position where they are spaced from the plate. In the particular example depicted, a user has pressed their face into the pins so as to create a three-dimensional relief image of their face.

This arrangement, whilst providing a user with the ability to form a three-dimensional surface, is somewhat limited in functionality. It is also rather bulky, and the cover detracts significantly from the aesthetic appeal of the device. As a result of these shortcomings, devices such as that shown in FIGS. 1 and 2 are largely considered to be novelty items, rather than as devices for displaying works of art.

A principal aim of the present invention is to provide a device which mimics the functionality of the “pin art” device aforementioned, and which provides additional functionality to that of the previously proposed device. Another aim of the present invention is to provide a device which is more aesthetically pleasing than that previously proposed.

### STATEMENT OF THE INVENTION

To this end, a presently preferred embodiment of the present invention provides a luminaire comprising: a light source, and a frame having a plurality of optic fiber stubs retained therein, said stubs being selectively movable by a user with respect to the frame to form a three-dimensional surface that may be lit by said light source when said frame is located in front of said light source and said light source is energised.

This aspect of the present invention is advantageous since as the fiber stubs are retained in the frame, there is no need for a cover plate (as with the prior art pin art) and as such the aesthetic appeal of the device is improved. In addition, by associating the frame with a light source it is possible for the user to form a three-dimensional lit surface.

The luminaire may further comprise a housing defining an aperture, said light source being located within said housing.

In a preferred arrangement the frame is removably locatable in said aperture so as to be spaced from said light source. This arrangement is particularly useful when the luminaire is configured to be mounted on a surface, such as a wall, as it allows the user to set their desired surface shape without having to remove the entire luminaire from the wall.

The housing may comprise a front cover that is attached to a back plate, the back plate being shaped and arranged so as to space the cover from a surface to which the housing is mounted, said back plate comprising one or more vents to enable air flow through the luminaire.

In another preferred arrangement the frame is coupled to the housing and movable between a first closed position where the aperture is closed by the frame and a second open position where the aperture is open.

Preferably the frame comprises a plurality of through-holes each of which has a diameter that enables a said optic fiber stub to be inserted therethrough.

In an advantageous arrangement, each of said optic fibre stubs comprises a shaft having a first diameter, a first end and a second end, said first and second ends having diameters which are larger than said first diameter and the diameter of said through-hole.

The housing may further comprise a slot, said slot being provided to enable a user to insert a diffuser, a filter or an image carrier between said light source and said optic fiber stubs. In this instance, the diffuser may be operable to diffuse light emitted by said light source so that substantially all of said stubs are illuminated when said light source is energised. The filter may be coloured, or the image carrier may comprise a transparent bearer having a user selected image printed thereon.

In a preferred arrangement, the light source comprises one or more elements that can be energised to emit light. The elements may be selected from the group consisting of: tungsten filament light bulbs, compact fluorescent lamps (also known as low energy bulbs or CFLs), halogen bulbs and LED light bulbs.

Preferably the luminaire includes an on/off switch that is user operable to energise or de-energise the light source.

In a particularly preferred arrangement, each said stub has a diameter between roughly 0.5 mm and 1 mm at its narrowest point. The through-holes may each have a diameter that is in the region of 5 to 20%, preferably 10 to 20%, larger than the diameter of the stubs.

The frame may comprise means operable to exert a resistive frictional force on said fiber optic stubs so as to retain said stubs in a user selected configuration.

In one embodiment, the luminaire may be configured and arranged to resemble a frame for a painting.

The housing may comprise a front cover that is attached to a back plate, the back plate being shaped and arranged so as to space the cover from a surface to which the housing is mounted, said back plate comprising one or more vents to enable air flow through the luminaire.

In accordance with another embodiment of the invention, there is provided a wall mountable luminaire, comprising: a housing defining an aperture, a light source located within the housing, a frame mountable in the aperture of the housing so as to be spaced from the light source, and a plurality of optic fiber stubs retained in said frame, wherein said stubs are less than 10 cm's in length and are selectively movable by a user with respect to the frame to form a three-dimensional surface that may be lit by said light source when said frame is mounted in said aperture and said light source is energised.

In accordance with a further embodiment of the invention there is provided a floor-standing luminaires, comprising: a housing defining an aperture, a light source located within the housing, a frame pivotally attached to the housing and movable between a first position in which the aperture is closed by the frame and a second position where the aperture is open; said frame being spaced from said light source when in said first closed position; and a plurality of optic fiber stubs retained in said frame, wherein said stubs are at least 10 cm's in length and are being selectively movable by a user with respect to the frame to form a three-dimensional surface that may be lit by said light source when said frame is in said first closed position and said light source is energised.

In accordance with another embodiment of the invention, there is provided a method of forming a three dimensional lit surface, the method comprising: providing a light source, and a frame having a plurality of optic fiber stubs retained therein; selectively moving said optic fibre stubs relative to said frame a three-dimensional surface, locating said frame in front of said light source, and energising said light source to light said surface.

In this embodiment the moving step may comprise pressing an object or a body part into the optic fibre stubs to form a three dimensional surface corresponding to that part of the object or body part pressed into the stubs.

Other features and advantages of embodiments of the invention are set out in the detailed description provided below.

### BRIEF DESCRIPTION OF THE DRAWINGS

Various preferred embodiments of the present invention will now be described, by way of illustrative example only, with reference to the accompanying drawings, in which:

FIG. 1 is a perspective view of a previously proposed pin art device;

FIG. 2 is a top plan view of the device is shown in FIG. 1;

FIG. 3 is a perspective view of selected components of a luminaire in accordance with a preferred embodiment of the present invention;

FIG. 4 is a front elevation of the luminaire depicted in FIG. 3

FIG. 5 is a schematic cross-sectional view along the line X-X of FIG. 3;

FIG. 6 is a schematic representation of an optic fiber stub as used in the luminaire of FIG. 3;

FIG. 7 is a front elevation of part of the luminaire of FIG. 3 depicting a preferred hole layout;

FIG. 8 is a schematic perspective view of a luminaire according to a second embodiment of the present invention in a closed configuration;

FIG. 9 is a schematic perspective view of the luminaire of FIG. 8 in an open configuration; and

FIG. 10 is a schematic perspective view of a luminaire according to a third embodiment of the present invention.

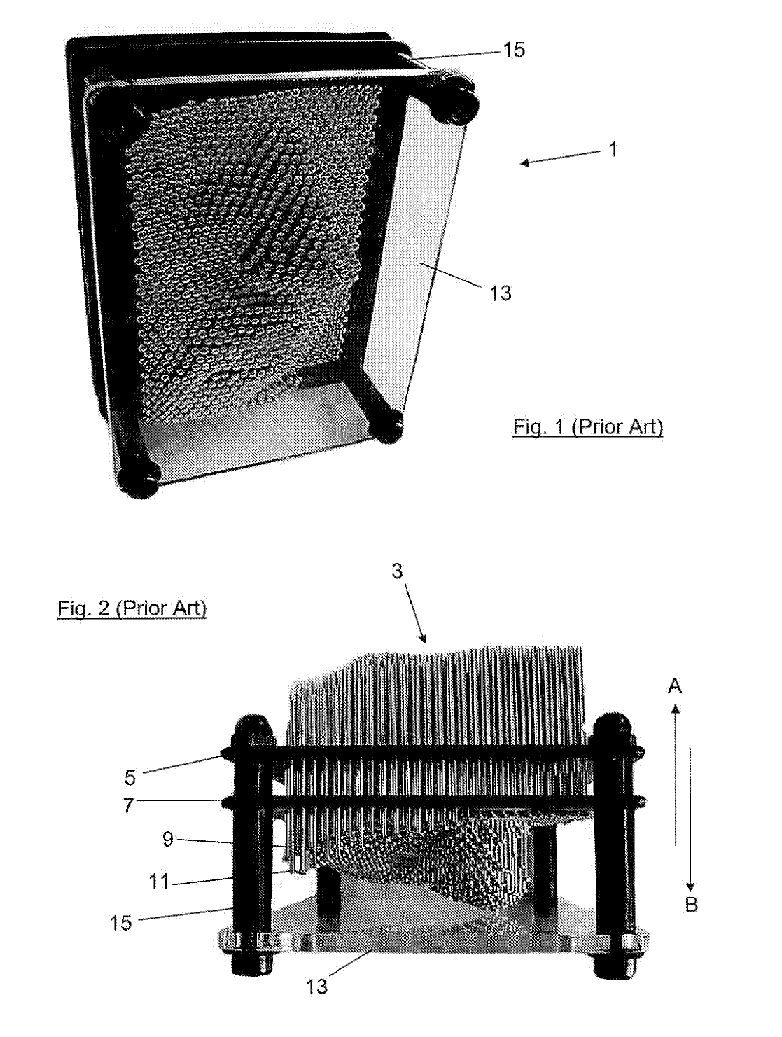

### DETAILED DESCRIPTION OF PREFERRED EMBODIMENTS

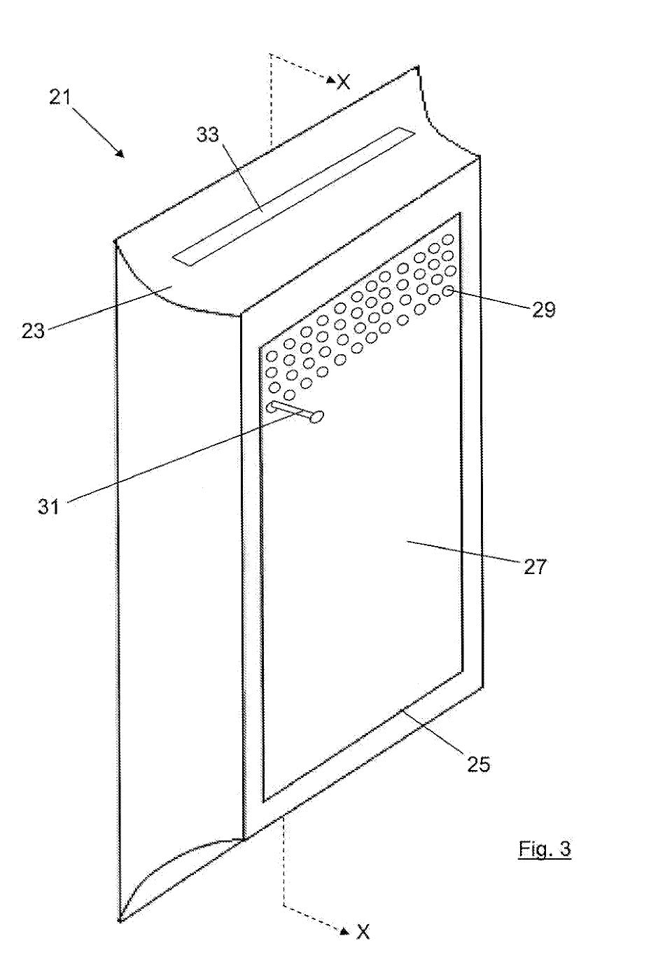

Referring now to FIG. 3 of the accompanying drawings, in this first preferred embodiment of the invention the luminaire 21 comprises a housing 23 that includes an aperture 25 into which a removable frame 27 has been fitted. In the preferred arrangement the frame forms a friction fit with the walls of the housing 23 that define the aperture 25. However, it will be appreciated by those persons skilled in the art that a variety of alternative fixing mechanisms may instead be employed if so desired.

It will also be apparent to persons skilled in the art, that the frame need not be wholly removable from the housing. For example, the frame could be hinged to the housing, or in an alternative arrangement the frame may not be removable from the housing. In this latter arrangement it may only be possible to form a negative relief image (relative to the frame), whereas in the preferred arrangement it is possible to form both negative and positive relief images.

The frame includes a plurality of through-holes 29 (a subset of which are shown) through each of which there is provided an optic fiber stub 31 (again, for clarity only one such stub is shown). As the configuration of the stubs will later be described, it suffices at this juncture to mention that the stubs are retained in the frame so that they will not fall out of the frame once they have been inserted through their respective through-holes.

To provide for a good resolution in the image visible through the ends of the optic fiber stubs it is preferred that the through-holes are spaced so that the fiber stubs extending therethrough form a substantially continuous surface. In other words, it is preferred that any spacing between adjacent stubs is reduced so as to be as small as possible.

In a preferred arrangement, wherein the frame is approximately 10 cm's by 15 cm's, the holes are roughly 1.1 mm's in diameter and roughly 2.5 mm's apart. Each stub has a diameter (at its narrowest point) of approximately 1 mm, and in total the frame comprises roughly 2,200 holes and corresponding stubs. In this preferred arrangement, the gaps between adjacent stubs are in the order of 1 mm or so. In another preferred arrangement the stubs have a diameter of approximately 0.5 mm and in this instance the frame comprises roughly 4,500 holes and corresponding fiber stubs. Each stub is less than 10 cm's in length (preferably roughly 4 cm's in length) and, as will later be described, is movable back and forth through the holes in the frame to allow the user to define a three-dimensional surface of their choosing. In general terms it is preferred that the diameter of the holes is in the region of 5 to 20%, preferably 10 to 20%, larger than the diameter of the stubs, and it is preferred (bearing in mind that the stub heads are larger than the stub shafts) that the holes are spaced such that the heads are as close together as possible.

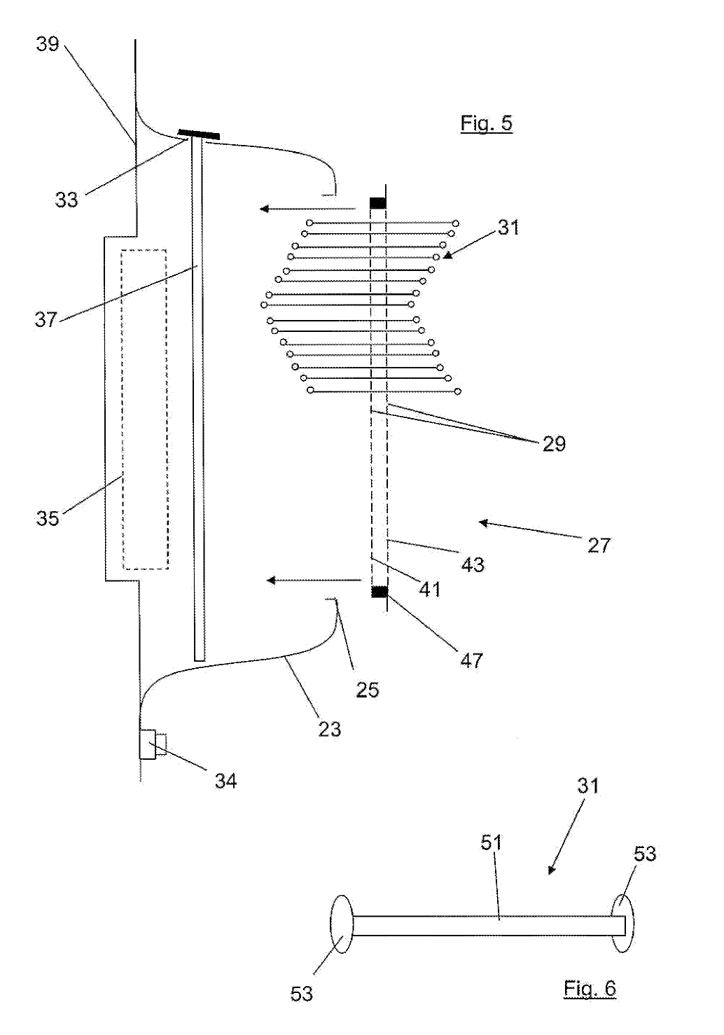

A light source 35 (see FIG. 5) is provided within the housing 23, and in a particularly preferred arrangement the housing includes a slot 33 into which a diffuser plate 37 (shown in FIG. 5) may be inserted between the light source 35 and the fiber stubs 31. The diffuser plate functions to diffuse light emitted by the light source so that substantially all of the stubs are illuminated by the light source, and in a particularly preferred arrangement all substantially equally illuminated by the light source. The diffuser plate may include a coloured filter (so that the image projected by the luminaire is coloured), and in a further modification an image to be projected may be printed on a transparent carrier (such as an acetate) and inserted between the plate and the stubs (or incorporated into the plate).

As will be appreciated by persons skilled in the art, the diffuser plate may not necessarily be required to enable the luminaire to function as intended. In general, a diffuser plate may not be required in circumstances where the light source comprises one or more light elements that are such that each fiber stub end is sufficiently illuminated. In circumstances where the diffuser plate is not provided the slot may still be used to enable a coloured filter to be inserted between the light source and the stubs. Alternatively the colour of the image protected by the luminaire may be changed by changing the light source to one that emits light of the desired colour.

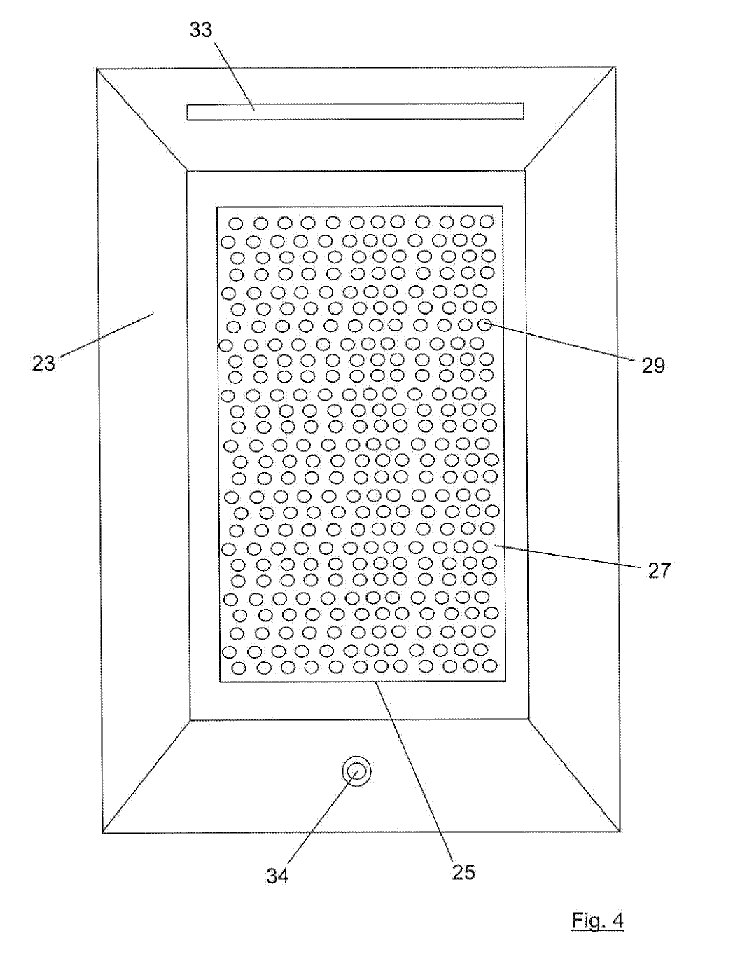

As shown in FIG. 4, the luminaire also includes an on/off switch 34 that is user operable to energise and de-energise the light source.

Referring now to FIG. 5, wherein the frame is shown separated from the housing, the light source 35 is located in a depression 37 formed in a back plate 39 which functions to space the luminaire from the surface (not shown) to which it is attached and thereby allow air flow through the luminaire to avoid excessive heat build up. One or more vents may be provided in the back plate to assist heat flow from the luminaire.

The light source may comprise a single element, or in a preferred arrangement a plurality of elements. For example, the light source may comprise one or more tungsten filament bulbs, or one or more LEDs (preferably cool running LEDs), one or more compact fluorescent lamps (also known as low energy bulbs or CFLs), one or more halogen bulbs or a combination of these, Any number of other suitable light source elements will be apparent to persons of ordinary skill in the art, and the skilled person will also appreciate that the choice of light source will depend to a lesser or greater extent on other factors such as the heat generated by the light source, and whether that heat might be hazardous in the particular configuration that the luminaire is to adopt.

As shown in FIG. 5, the frame of this embodiment comprises a pair of parallel plates 41, 43 that are spaced from one another by a peripheral connector 47 which holds the plates roughly 1 cm apart. As aforementioned, each plate is provided, with a plurality of through-holes 29, and the two plates are arranged so that the holes in one plate align with those in the other. In this arrangement, two plates are provided to ensure that each of the fiber stubs are properly supported. In an alternative arrangement the frame may comprise a single thicker plate.

In the preferred embodiment the fiber stubs are freely movable back and forth through the holes in the frame. It may be beneficial, however, if motion of the stubs through the holes is resisted. To provide such resistance the frame may include a resilient sheet (not shown), for example of rubber, that is provided with a plurality of holes which are aligned with those of the plate. The holes in the resilient sheet are smaller than those of the plate and as a consequence of this a relatively small frictional force is exerted by the sheet on the fiber stubs which allows the stubs to be held in place once they have been moved to their desired configuration. This arrangement is particularly preferred as it should enable a user to avoid spoiling a pattern that they have prepared by accidentally moving stubs to a position that is not desired.

Referring now to FIG. 6, the stubs 31 each comprise a stub shaft 51 that is enlarged at either end to form respective stub heads 53. The stub shaft is smaller in diameter than the holes in the frame, and the stub heads are larger than the holes in the frame so as to retain the stubs within the frame.

In the preferred embodiment the larger fiber heads are formed by pressing each end of the stubs against a hot implement, such as a soldering iron, to partially melt and squash the stub ends to increase their size.

To assemble the luminaire, one end of each stub is squashed, following which the stubs are located in their respective holes in the frame. Next the other end of each of the stubs is squashed to thereby retain the stubs in the frame. Repeating this process by hand for all of the stubs is quite labour intensive, and in an alternative arrangement the stubs may be located in the holes, following which hot plates are pressed (in one arrangement simultaneously) against the stub ends to melt and squash the ends of each stub and thereby retain the stubs in the frame. To reduce the chance of adjacent stub heads melting together, it is conceivable that a jig may be provided, the jig being operable to push alternate stubs through the frame and against the hot plate.

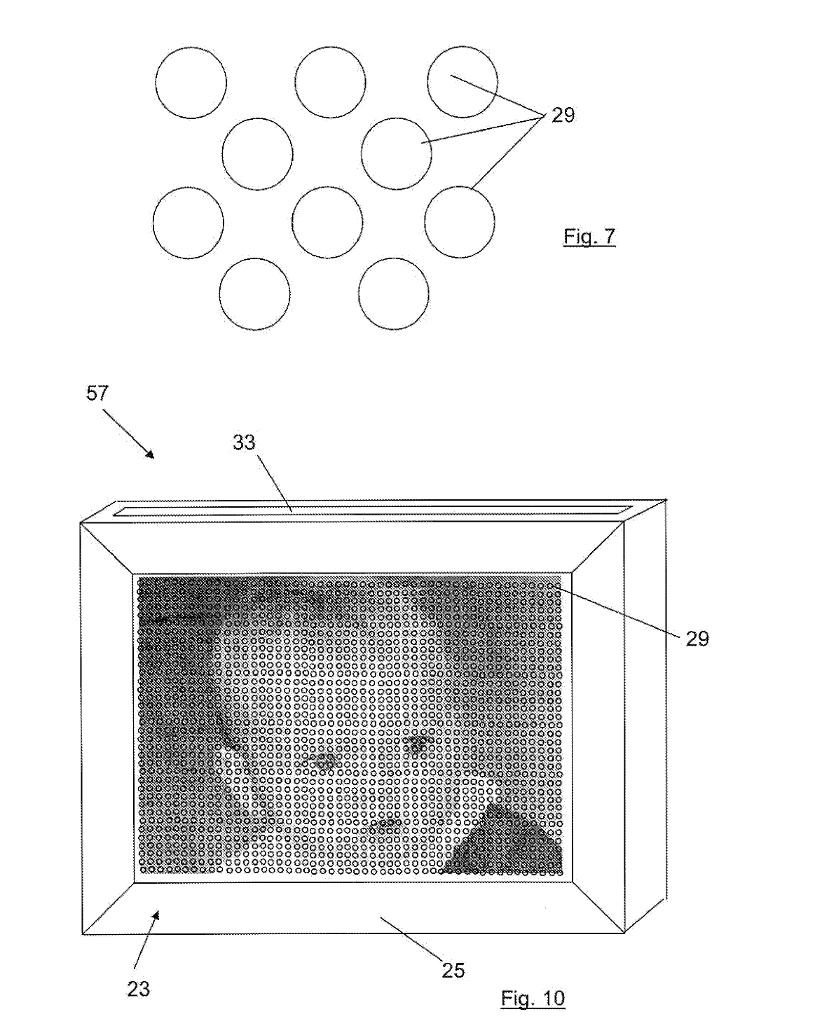

Referring now to FIG. 7 of the drawings, there is shown a preferred pattern for the holes 29 in the frame 27. As shown, it is preferred for the holes of a given row to be aligned with spaces between holes in the immediately adjacent rows, as this arrangement allows for the spacing between adjacent holes to be reduced as far as is practicable.

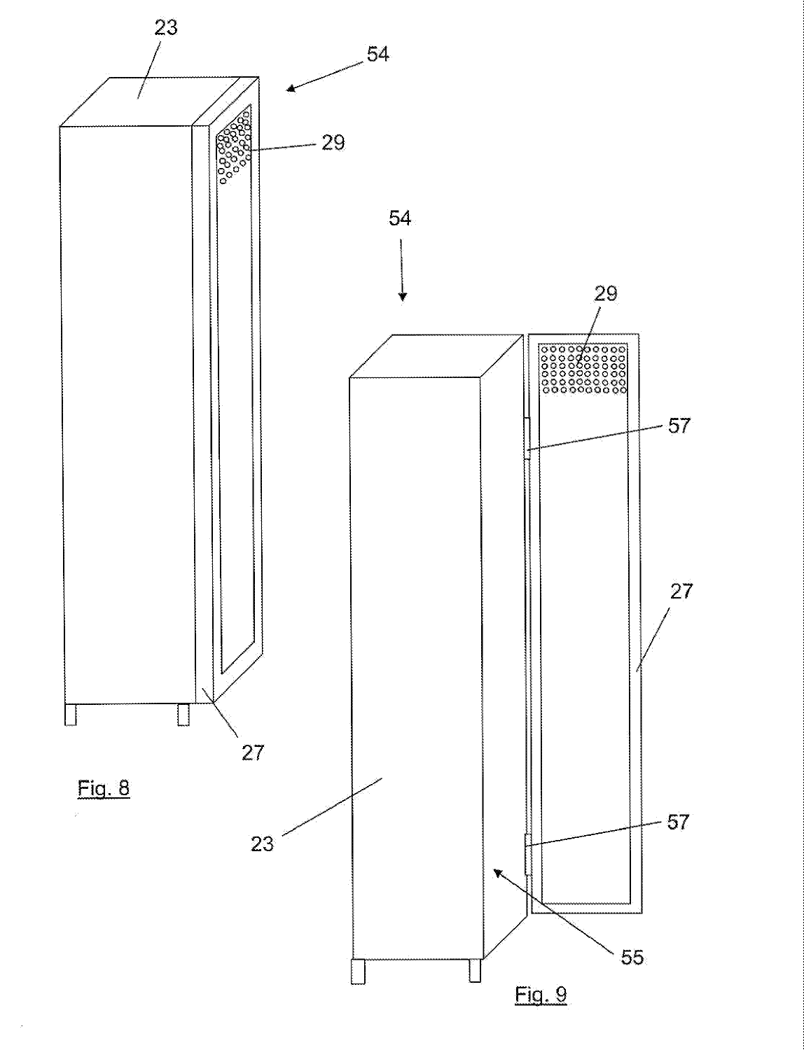

FIGS. 8 and 9 are schematic representations of a luminaire according to a second embodiment of the invention in closed and open configurations, respectively. Whereas the aforementioned first embodiment is designed for mounting on a wall, the luminaire according to this second embodiment is designed as a floor-standing unit.

Referring now to FIG. 8, the luminaire 54 of this embodiment is much larger than that of the first embodiment. In one illustrative arrangement the luminaire is approximately 2.0 m in height and 40 cm's wide, so that a user can press their whole body against the fiber stubs to form an image should they wish to do so. In this configuration it is preferred for the stubs to be much longer than those of the first embodiment, for example at least 10 cm's in length, preferably from 10 to 15 cm's in length.

In this embodiment the housing 23 of the luminaire is a rectangular parallelepiped that is open at one face 55. As before, one or more light sources (not visible) are provided within the housing, and the housing may include, as before, a slot (not shown) to enable one or more of diffuser plates, acetates or filters to be inserted between the fiber stubs and the light source(s).

The frame 27 of this embodiment is hinged to the housing by hinges 57, and includes a plurality of holes 29, only a subset of which are illustrated in FIGS. 8 and 9. As before, each of the holes has an optic fiber stub (not shown) inserted through it, and the stubs are movable by a user to form a desired three-dimensional pattern. The frame may have in the region of 120,000 stubs mounted in it.

FIG. 10 is a schematic representation of a third envisaged embodiment of the present inventions. In this embodiment the housing 23 of the luminaire 57 is configured to resemble a frame for a painting. The front face (shown) of the housing 23 forms the frame for carrying a plurality of fiber optic stubs, and the housing includes a slot 33 to enable an acetate (visible through the through-holes in the frame) to be inserted between the light source(s) and the ends of the fiber stubs. This arrangement allows the user to convert an image of their choosing into a three-dimensional image, and in the example depicted the user has chosen to insert a family photograph into the housing. By manipulating the fiber stubs appropriately the user can then form a three-dimensional surface which confirms to the facial features of each of the persons featured in the photograph, thereby enabling the display of a three-dimensional representation of the image chosen.

As will be appreciated from the foregoing, to form a desired three-dimensional surface a user need only push (or pull) the fiber stubs a desired distance through the frame. In the first embodiment this is most easily done by removing the frame from the housing, and manipulating the stubs from the back of the frame (i.e. that side which is closest to the light source in use). In the second embodiment this is most easily accomplished by opening the housing and then pushing pins from the rear of the hinged frame (again, in this instance the rear of the frame is that side which lies closest to the light source in use). Once the desired pattern has been formed the user need only replace the frame in the housing (being careful to ensure that the pattern is not disturbed) or move the frame to the closed position to being using the luminaire. Once the frame is in place, the user can then energise the light source, and light emitted from the source will be visible through the ends of the fibre stubs projecting from the frame.

Advantageously, the optic fiber stubs are such that light does not leak from the side of the stub (at least to a user appreciable degree), and this enables the three-dimensional nature of the pattern to be easily visible—particularly when viewed from a position off-set from the front of the frame.

It will be understood, of course, that the various embodiments described herein have been described by way of example only and that modifications may be made thereto without departing from the spirit and scope of the present invention as defined in the accompanying claims.

For example, the frame described herein may—in a preferred arrangement—include a support to enable the frame to be stood in a generally upright configuration on a surface. This arrangement allows the frame to be used separately from the luminaire as a conventional pin art device. The luminaire herein described may also be configured as a smaller free-standing device, such as a table lamp.

It is also conceivable that the optic fiber stubs ends may not be squashed so as to be retained in the frame, but may instead be retained in the frame solely by a resilient sheet (of the type aforementioned) located behind or within the frame. Such an arrangement is, however, not preferred as it would be more difficult to “reset” the luminaire, and pressing a body part against the stubs may be painful.

It is also conceivable, as an alternative to heating the ends of the stubs to form the larger heads, to apply a measure of transparent glue to the fiber shafts to form the larger stub heads. Other alternative methods for forming larger fiber heads will be immediately evident to persons of ordinary skill in the art.

1. A luminaire comprising:
a light source, and
a frame having a plurality of optic fiber stubs retained therein, said stubs being selectively movable by a user with respect to the frame to form a three-dimensional surface that may be lit by said light source when said frame is located in front of said light source and said light source is energised.

2. A luminaire according to claim 1 further comprising a housing defining an aperture, said light source being located within said housing.

3. A luminaire according to claim 2, wherein said frame is removably locatable in said aperture so as to be spaced from said light source.

4. A luminaire according to claim 2, wherein said frame is coupled to the housing and movable between a first closed position where the aperture is closed by the frame and a second open position where the aperture is open.

5. A luminaire according to claim 1, wherein said frame comprises a plurality of through-holes each of which has a diameter that enables a said optic fiber stub to be inserted therethrough.

6. A luminaire according to claim 5, wherein each of said optic fibre stubs comprises a shaft having a first diameter, a first end and a second end, said first and second ends having diameters which are larger than said first diameter and the diameter of said through-hole.

7. A luminaire according to claim 2, wherein said housing further comprises a slot, said slot being provided to enable a user to insert a diffuser, a filter or an image carrier between said light source and said optic fiber stubs.

8. A luminaire according to claim 7, wherein said diffuser is operable to diffuse light emitted by said light source so that substantially all of said stubs are illuminated when said light source is energised.

9. A luminaire according to claim 7, wherein said filter is coloured.

10. A luminaire according to claim 7, wherein said image carrier comprises a transparent bearer having a user selected image printed thereon.

11. A luminaire according to claim 1, wherein said light source comprises one or more elements that can be energised to emit light.

12. A luminaire according to claim 11, wherein one or more of said elements are selected from the group consisting of: tungsten filament light bulbs, compact fluorescent lamps, halogen bulbs and LED light bulbs.

13. A luminaire according to claim 1, further comprising an on/off switch that is user operable to energise or de-energise said light source.

14. A luminaire according to claim 1, wherein each said stub has a diameter of roughly 0.5 mm or 1 mm at its narrowest point.

15. A luminaire according to claim 5, wherein each said through-hole has a diameter that is in the region of 5 to 20%, preferably 10 to 20%, larger than the diameter of the stubs.

16. A luminaire according to claim 1, wherein said frame further comprises means operable to exert a resistive frictional force on said fiber optic stubs so as to retain said stubs in a user selected configuration.

17. A luminaire according to claim 1, wherein said luminaire is configured and arranged to resemble a frame for a painting.

18. A luminaire according to claim 2, wherein said housing comprises a front cover that is attached to a back plate, the back plate being shaped and arranged so as to space the cover from a surface to which the housing is mounted, said back plate comprising one or more vents to enable air flow through the luminaire.

19. A wall mountable luminaire, comprising:
a housing defining an aperture,
a light source located within the housing,
a frame mountable in the aperture of the housing so as to be spaced from the light source, and
a plurality of optic fiber stubs retained in said frame, wherein said stubs are less than 10 cm's in length and are selectively movable by a user with respect to the frame to form a three-dimensional surface that may be lit by said light source when said frame is mounted in said aperture and said light source is energised.

20. A floor-standing luminaire, comprising:
a housing defining an aperture,
a light source located within the housing,
a frame pivotally attached to the housing and movable between a first position in which the aperture is closed by the frame and a second position where the aperture is open; said frame being spaced from said light source when in said first closed position; and
a plurality of optic fiber stubs retained in said frame, wherein said stubs are at least 10 cm's in length and are being selectively movable by a user with respect to the frame to form a three-dimensional surface that may be lit by said light source when said frame is in said first closed position and said light source is energised.
